(19) United States
(12) Patent Application Publication
(10) Pub. No.: US 2017/0109945 A1
(43) Pub. Date: Apr. 20, 2017

(54) Machine to Machine Communication to Transmit and Receive Machine Information

(71) Applicant: Caterpillar Inc., Peoria, IL (US)

(72) Inventor: Michael Hague, Washington, IL (US)

(73) Assignee: Caterpillar Inc., Peoria, IL (US)

(21) Appl. No.: 14/886,291

(22) Filed: Oct. 19, 2015

(51) Int. Cl. G07C 5/00; H04B 7/155

(52) U.S. Cl. CPC G07C 5/008; H04B 7/15507

(57) ABSTRACT

A data communication system for construction machines for uploading data from and downloading data to other construction machines that may have better and/or more frequent communication connectivity to an off-board computer that is connected to a computer network.

### TECHNICAL FIELD

The present disclosure relates to a data communication system for allowing construction machines to upload data from and download data to other construction machines that may have better and/or more frequent communication connectivity to an off-board computer.

### BACKGROUND

There have been recent innovations in diagnostic collecting and transmission systems for use in connection with construction machines. Such diagnostic systems and advanced sensor arrays produce a tremendous amount of information. This information allows the operating level of the construction machine, that is, its performance, efficiency, and other operating characteristics to be known and controlled based upon the information. Some of this information may be used on board the construction machine to perform low level diagnostics. However, due to on-board computing power limitations and the lack of operator expertise in using this information to diagnose the construction machine and its systems, the information may be more useful off-board the construction machine. Off-board the information may be used to perform diagnostics, prognostics (the ability to prevent a breakdown before it occurs), and also to develop new diagnostics and prognostics. Consistent therewith, such advances include the ability of a “back office” control computer for communicating information relating to diagnostic procedures, software updates, preventative maintenance, etc. to and downloading information from the construction machine. Such diagnostic systems have allowed construction machines, particularly those located at remote work sites, to perform on-board diagnostics to reduce downtime by preventing certain kinds of breakdowns.

There are a number of ways in which the aforementioned information may be relayed from construction machines to locations where it may be used fully. For example, if the construction machine includes a control module which includes a storage medium such as a battery backed static ROM, then an external computer, such as a portable or laptop computer, may be connected to a data link on the construction machine and information downloaded to the external computer via a hardwire connection. Further, if the construction machine is equipped with the necessary communication equipment, the information can be transferred via Bluetooth, WiFi, etc. Another way that information may be transferred from the construction machine to the remote location is through a telecommunication system, for example, cellular, satellite, radio, or other transmission means.

As discussed briefly above, the information gathered from such construction machines may be useful in many different ways. For example, a fleet manager may use the information to schedule and review work schedules. Additionally, a service center and/or a dealer may use the information to review the status, schedule maintenance and to diagnose problems related to a fleet of vehicles and/or plurality of machines. Further, it may be necessary to download software updates or other solutions which may solve issues which construction machines may experience or in order to prevent break downs or other downtime in the future. For at least all of these reasons, it is very useful to maintain the ability of construction machines equipped with such advanced diagnostic and information collection equipment to maintain communication contact with the off-board network (i.e. the “back office” computer and/or network).

In this regard, U.S. Pat. No. 7,034,710 to Caterpillar, Inc. describes a system of collecting, downloading transmitting and receiving, such information. Specifically, that patent discloses a system and method for displaying information related to the status of at least one machine of a plurality of machines. The system disclosed in the '710 patent describes machines that include data modules coupled to each of the plurality of machines that are adapted to collect and store information related to the corresponding machines. While the machines disclosed in the '710 patent are provided with data links that are adapted to transmit data information between the data modules coupled to each machine and the display modules on the machines, the system disclosed therein does not disclose a system wherein the machines can transmit and/or receive information from similar machines that have telecommunications capability with the “back office” computer and/or network as may be useful for the reasons discussed below.

Specifically, in the construction industry, and in particular the mining construction industry, it is common for construction machines, i.e. wheel loaders, primary loaders, draglines, etc., to be located in very remote areas, where communication capability may be limited. Further, such environments can be particularly harsh which may adversely affect the range of transmission and/or reception of any communication equipment used by any such construction machine. Given the aforementioned value and benefit of being able to maintain communication between construction machines and a back office computer and/or network (an internal network and/or the Internet or other networks), diminished or lost communication in construction equipment can be problematic.

Accordingly, it would be useful to have a system and/or method of communication of information to and/or from construction machines to back office computer and/or network that acts as a secondary or back-up communication network when a primary mode of communication is damaged, unreliable, or otherwise unavailable for use.

### SUMMARY

As discussed herein, the capability of construction machines to collect and transmit information, including, but not limited to, diagnostic, prognostic, preventative maintenance, etc. information to an off-board computer and/or network as well as to receive and implement such information (as well as software upgrades, etc.) has resulted in an increased need to improve communication capabilities of such construction equipment. Thus, while prior art systems disclosing either hard-wired downloading methods, or even through the use of on-board telecommunications systems maybe operable in many circumstances, there is an ongoing need for back-up communication systems that can be used when necessary.

The need for a back-up system may be particularly attenuated in circumstances where the construction machine being utilized is a mining construction machine and either the location of the machine is so remote that certain transmission methods are inoperable (for example, cellular or other telecommunication devices), wherein the construction machine is located so far from the back-office computer or network as to not have sufficient range (such as for example, Bluetooth), or wherein the primary communication system has been damaged or its range has otherwise been compromised.

In accordance therewith, at least one aspect of the present disclosure provides a method and system for providing a back-up communication system for a construction machine that collects, transmits and receives information from an off-board computer network. The back-up communication system of the present disclosure comprises providing a first construction machine with communication capability with other construction machines so that if communication ability between the first construction machine and the off-board computer and/or network is lost or inoperable, the first construction machine can transmit and/or receive information from the other machine for communication to/from the off-board computer and/or network.

In accordance with another aspect of the disclosure, a method and system is provided for a first construction machine that collects and/or transmit information that has lost connectivity to an off-board computer and/or network to communicate with surrounding construction machines to determine a last connection time and/or frequency of communication with which those construction machines have had successful communication with an off-board computer and/or network and then to transmit and/or receive information from the construction machine having the most recent communication or the most frequent regular communication for relay to/from the off-board computer and/or network.

In accordance with yet another aspect of the disclosure, a relay communication system may be established between multiple construction machines wherein a first machine may transfer/receive information to/from a second construction machine that may transfer/receive information to/from an off-board computer and/or network.

In accordance with another aspect of the disclosure, construction machines disclosed herein may prioritize information transfer first for the construction machine that has lost communication contact with the off-board computer and/or network. Conversely, in accordance with another embodiment, information transfer can be prioritized for the construction machine that acts as a carrier for the information transferred from another construction machine. In yet another embodiment, information can be assigned priority grades and information with the highest priority grades could be transferred first and the information with the lowest priority grade could be transferred last regardless of the construction machine to which the information pertains.

### BRIEF DESCRIPTION OF THE DRAWINGS

FIG. 1 is a schematic and diagrammatic representation of an exemplary mine layout; and

FIG. 2 is schematic and diagrammatic illustration of an exemplary construction machine monitoring system.

### DETAILED DESCRIPTION

With reference to the drawings and in operation, the present disclosure provides a construction machine to construction machine communication system for allowing a construction machine having frequent and/or strong communication connectivity with an off-board computer and/or network to relay information to/from a construction machine having infrequent and/or weak communication with the off-board computer and/or network.

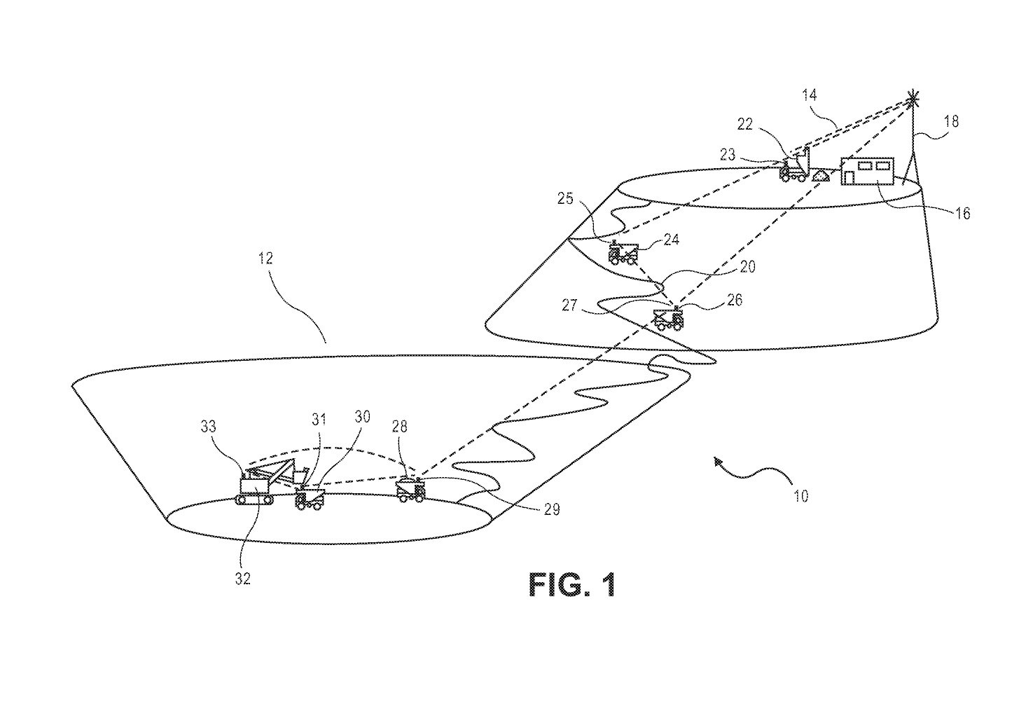

In accordance with the foregoing, FIG. 1 schematically and diagrammatically illustrates an open pit mine operation 10 including an open pit mine 12 and a processing region 14 having an office 16, the office including a computer therein 17 connected to a computer network (not shown) and having a cellular communication tower 18 connected thereto, either by wired connection 19 or wireless connection. The open pit mine 12 may be connected to the processing region 14 by at least one haul route 20. The open pit mine operation 10 may include a fleet of construction machines comprising, for example, wheel loaders 22, 24, 26, 28, 30 that may travel from the area of excavation of the open pit mine 12 along the haul route 20 to the processing region 14. In the open pit mine 12, another machine, such as a dragline 32, may operate to excavate material, which may be ore or overburden, and which may be loaded into any of the wheel loaders 22, 24, 26, 28 and 30.

The wheel loaders 22, 24, 26, 28, 30 may carry a payload, e.g., the excavated material, when traveling from the open pit mine 12 to the processing region 14. Thus, in an exemplary haulage cycle, a payload may be loaded onto the wheel loader 30, the wheel loader 30 may travel along its assigned haul route 20 from the mine 12 to the processing region 14, where the payload may be unloaded from the wheel loader 30, and then the wheel loader 30 may travel along its assigned haul route 20 back to the mine 12 from the processing region 14. Each wheel loader 22, 24, 26, 28, 30 may be assigned to a specific haul route 20 for a particular day, week, or other period of time, or until a particular haulage operation is completed.

The wheel loaders 22, 24, 26, 28, 30 may be large, off-road vehicles. It should be noted that the disclosed embodiment may be applicable to other types of wheel loaders such as, for example, on-highway trucks or other earth moving machinery capable of carrying a payload. The disclosed embodiment may also be applicable to a mobile machine that performs some type of operation associated with an industry such as mining, construction, farming, transportation, or any other industry known in the art. For example, the machines may be commercial machines, such as trucks, cranes, earth moving machines, mining vehicles, material handling equipment, farming equipment, marine vessels, aircraft, excavators, dozers, loaders, backhoes, motor graders, dump trucks, or any type of machine that operates in a work environment such as a construction site, mine site, power plant, etc.

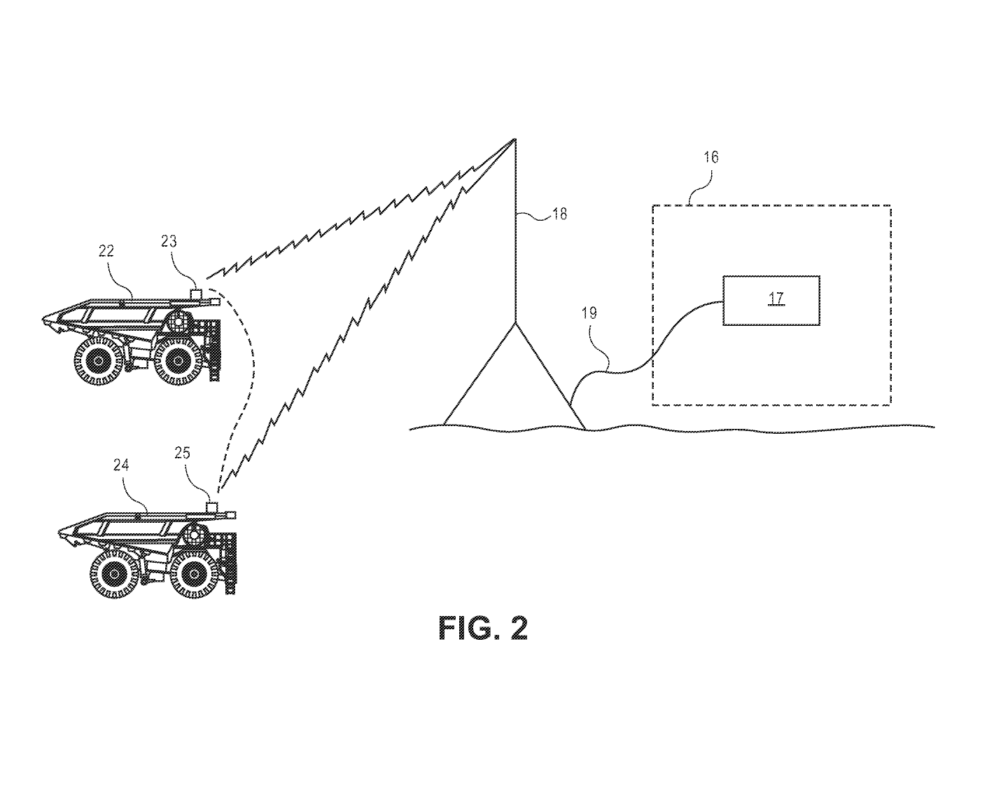

The point of excavation within the mine 12 and the processing region 14 may be at different elevations. As a result, the wheel loaders 22, 24, 26, 28, 30 may transport excavated material along the haul route 20 at least in part from a lower elevation to a higher elevation. The wheel loaders 22, 24, 26, 28, 30 may be equipped with transmission equipment allowing them to transmit and/or receive information from an off-board, back office computer system 40 (see FIG. 2) through the cellular communication tower 18. Depending on the location of the wheel loaders 22, 24, 26, 28 and 30 within the mine 12, and/or depending on the status of the telecommunication equipment located on the wheel loaders, communication between the wheel loaders and the cellular communication tower 18 may not be possible or may be infrequent. Additionally, given the location of the dragline 32 within the mine, telecommunication with the cellular communication tower 18 may be impossible.

FIG. 2 illustrates an embodiment of a construction machine monitoring system in accordance with the disclosure. The construction machine monitoring system may include a plurality of communicating devices 23, 25 each associated with one of the construction machines 22, 24 respectively. The communicating devices 23, 25 may be configured to communicate with the back office computer 17, and/or each other through a communication network 74. The communication network 74 may include a wireless network, wired network, or a combination thereof. The wireless network may include a satellite network, a cellular network, a radio frequency network, a Bluetooth network and/or other forms of wireless communication. In addition, the communication network 74 may include wired networks such as a network with a modem with access to a public, or private, telephone line, a fiber optic or coaxial cable based network, a twisted pair telephone line network, or any other type of wired communication network.

The back office computer 17 may be a controller that is programmed and configured for receiving and processing information from each of the construction machines 22, 24, 26, 28, 30 and 32 and also for transmitting information to each of the communicating devices 23, 25, 27, 29, 31 and 33, respectively on each of the construction machines 22, 24, 26, 28, 30 and 32. For example, the back office computer 17 may include a number of conventional devices including a microprocessor (not shown), a timer (not shown), input/output devices (not shown), a memory device (not shown), and a communicating device (not shown). The back office computer 17 may be located proximate the mine operation 10 or at a considerable distance remote therefrom. The back office computer 17 may be located in a remote station, a monitoring facility, a central data facility, or other facility capable of exchanging information with at least one construction machine communicating device. For example, the back office computer 17 may be located in a fixed or mobile office capable of communicating and processing equipment/process information, or capable of passing the information to another facility to perform this analysis. The back office computer 17 may be located within or close to the mine operation 10, or at a facility situated at a remote location.

The back office computer 17 may be suitably programmed and configured to compare the information received from the fleet of construction machines 22, 24, 26, 28, 30 and 32 with predetermined data or data or information received at the back office computer in real time through a computer network. The back office computer 17 may update one or more of the operation characteristics for one or more of the construction machines 22, 24, 26, 28, 30 and 32. The update may occur periodically (e.g., weekly, daily, hourly, etc.), after a predetermined operation or shift is complete, or after another predetermined event has a occurred. For example, one of the operation characteristics for a particular construction machine, e.g., a target and/or measured payload amount or haul route 20 characteristic (e.g., location, curvature, length, elevation, road grade, total effective grade, moisture, torque estimate, etc.), analytics, prognostics, diagnostics, maintenance schedules may be updated.

In accordance with the disclosure, construction machines 22, 24, 26, 28, 30 and 32 are adapted to collect information and transmit that information to the communication tower 18 for transmission to the back office computer 17 as well as to transmit information, through their respective communicating devices 23, 25, 27, 29, 31 and 33, respectively, to each other. Conversely, construction machines 22, 24, 26, 28, 30 and 32 are adapted to receive information from the back office computer 17 as transmitted through the communication tower 18 as to receive information through their respective communicating devices 23, 25, 27, 29, 31 and 33, respectively, from each other. The transmitted information may include, but is not limited to, information relating to diagnostics, prognostics, preventative maintenance, software upgrades, etc.

Further in accordance with the disclosure, the construction machines 22, 24, 26, 28, 30 and 32 are adapted to determine when they either are unable to transmit information to the communication tower 18 and/or receive information from the communication tower 18. In such a circumstance, the construction machines 22, 24, 26, 28, 30 and 32 may either alert an operator thereof of the communication issue or automatically switch to a secondary communication system. The construction machine experiencing communication then may default to a secondary communication system (such as blue tooth) or attempt to make contact with any other construction machine through the primary communicating device 23, 25, 27, 29, 30, 32. Then, once verifying communication connectivity with at least one communicating device of another construction machine, transmit information to that construction machine. The construction machine receiving that information may then transmit the information to communication tower 18.

The system described above may work in reverse as well. Specifically, the back office computer 17 may be adapted to determine when it is unable to transmit information to a particular construction machine. In such a circumstance, the back office computer 17 may either alert an operator thereof of the communication issue or automatically switch to a secondary communication system. The back office computer 17 may then select another construction machine not experiencing communication issues and send information to that machine. That machine may then, in turn, transmit the information on to the construction machine experiencing communication issues.

In another aspect of the disclosure, construction machines 22, 24, 26, 28, 30 and 32 that have lost connectivity to an back office computer 17 may be adapted to determine a last connection time and/or frequency of communication that the other construction machines have with the back office computer 17. That construction machine may then choose to transmit information to the construction machine which has the most recent connection with the back office computer 17 or which has the most frequent communication with the back office computer 17. This system may also be operated in reverse as well. Specifically, when the back office computer recognizes a communication issue with any one of the construction machines 22, 24, 26, 28, 30 and 32, the back office computer 17 is adapted to determine which construction machine has had the most recent communications with and/or most frequent communications with the construction machine undergoing communications issues. The back office computer 17 may then choose to transmit information to the construction machine which has the most recent and/or most frequent connection with the construction machine experiencing communication issues.

In accordance with another aspect of the disclosure, a multiple relay communication system may be established between multiple construction machines wherein when a first construction machine is experiencing communication issues with the back office computer 17 but cannot establish communication with any other construction machine which has established frequent and/or recent communication with the back office computer 17. In such a circumstance, the construction machine experiencing communication issues may transmit information to any construction machine with which it can establish communications. That construction machine, particularly if it is a mobile construction machine, may then later establish communication with a third construction machine which is able to establish communication with the back office computer 17.

In accordance with another aspect of the disclosure, construction machines 22, 24, 26, 28, 30 and 32 disclosed herein may prioritize information transfer first for the construction machine that has lost communication contact with the back office computer 17. Conversely, in accordance with another embodiment, information transfer can be prioritized for the construction machine 22, 24, 26, 28, 30 and 32 that acts as a carrier for the information transferred from another construction machine. In yet another embodiment, information can be assigned priority grades and information with the highest priority grades could be transferred to the back office computer 17 first, regardless of which construction machine 22, 24, 26, 28, 30 and 32 pertains, and the information with the lowest priority grade could be transferred last.

### INDUSTRIAL APPLICABILITY

The disclosed system and method of maintaining a back-up communication system for construction machines may be applicable to most any and all types of construction machines and industries. The disclosed system and method may increase construction machine efficiency and lessen the amount of construction machine downtime.

The many features and advantages of the disclosure are apparent from the detailed specification, and thus, it is intended by the appended claims to case all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

I claim:

1. A data communication system for transmitting data from a construction machine to an off-board computer comprising:
a first construction machine having a communication device associated therewith capable of communicating with an off-board computer and a second construction machine, the communication device being configured to transmit and receive information pertaining to the first construction machine;
a second construction machine having a communication device associated therewith capable of communicating with the off-board computer and the first construction machine, the communication device being configured to transmit and receive information pertaining to the second construction machine and the first construction machine;
wherein when the communication device of the second construction machine receives information from the first construction machine, the second construction machine transmits the information to the off-board computer.

2. The data communication system of claim 1 wherein when the second construction machine receives information from the off-board computer pertaining to the first construction machine, the second construction machine transmits the information to the first construction machine.

3. The data communication system of claim 1 wherein the off-board computer is a back-office computer.

4. The data communication system of claim 1 wherein the off-board computer is connected to a worldwide computer network.

5. The data communication system of claim 1 wherein the one of the first and second construction machines is a wheel loader.

6. The data communication system of claim 1 wherein the first construction machine is adapted to determine that the first construction machine communication device is unable to communicate with the off-board computer and thereafter transmit information to the second construction machine.

7. The data communication system of claim 1 further comprising a third construction machine adapted to receive information from the second construction machine pertaining to the first construction machine that is capable of transmitting the information to the off-board computer.

8. The data communication system of claim 1 wherein the first construction machine includes a secondary communication device capable of communicating with the second construction machine.

9. The data communication system of claim 1 wherein the first construction machine is adapted to determine a connection frequency of the second construction machine with the off-board computer.

10. A data communication system for transmitting data from a construction machine to an off-board computer comprising:
a first construction machine having a first communication device associated therewith capable of communicating with an off-board computer, a secondary communication device associated therewith capable of communicating with a secondary communication device associated with a second construction machine, the first communication device and the secondary communication device being configured to transmit and receive information pertaining to the first construction machine;
a second construction machine having a first communication device associated therewith capable of communicating with the off-board computer, a secondary communication device associated therewith capable of communicating with the secondary communication device of the first construction machine, the communication device being configured to transmit and receive information pertaining to the second construction machine and the first construction machine;
wherein when the secondary communication device of the second construction machine receives information from the secondary communication device of the first construction machine, the second construction machine transmits the information to the off-board computer.

11. The data communication system of claim 10 wherein when the second construction machine receives information from the off-board computer pertaining to the first construction machine, the second construction machine transmits the information to the first construction machine using the secondary communication device.

12. The data communication system of claim 10 wherein the secondary communication device of the first construction machine is a Bluetooth or WiFi communication device.

13. The data communication system of claim 10 wherein the off-board computer is connected to a worldwide computer network.

14. The data communication system of claim 10 wherein the first construction machine is adapted to determine that the first construction machine first communication device is unable to communicate with the off-board computer and thereafter transmit information to the second construction machine via the secondary communication device.

15. The data communication system of claim 10 further comprising a third construction machine adapted to receive information from the second construction machine pertaining to the first construction machine that is capable of transmitting the information to the off-board computer.

16. The data communication system of claim 10 wherein the first construction machine is adapted to determine a connection frequency of the second construction machine with the off-board computer.

17. A data communication system for transmitting data from a construction machine to an off-board computer comprising:
a first construction machine having a first communication device associated therewith capable of communicating with an off-board computer, a secondary communication device associated therewith capable of communicating with a secondary communication device associated with a second construction machine, the first communication device and the secondary communication device being configured to transmit and receive information pertaining to the first construction machine;
a second construction machine having a first communication device associated therewith capable of communicating with the off-board computer, a secondary communication device associated therewith capable of communicating with the secondary communication device of the first construction machine, the first communication device and secondary communication device being configured to transmit and receive information pertaining to the second construction machine and the first construction machine;
wherein when the secondary communication device of the second construction machine receives information from the secondary communication device of the first construction machine, the second construction machine transmits the information to the off-board computer using the first communication device of the second construction machine.

18. The data communication system of claim 17 wherein the information transmitted from the first construction machine to the second construction machine comprises information pertaining to diagnostics, prognostics, or preventative maintenance

19. The data communication system of claim 17 wherein information transmitted from the second construction machine to the off-board computer may be graded based upon priority and transmitted in order of highest priority grade first and lowest priority grade last.

20. The data communication system of claim 17 further comprising a third construction machine adapted to receive information from the second construction machine pertaining to the first construction machine that is capable of transmitting the information to the off-board computer.
